(19) United States
(12) Patent Application Publication
(10) Pub. No.: US 2013/0010317 A1
(43) Pub. Date: Jan. 10, 2013

(54) PRINTING APPARATUS MANAGING APPARATUS AND PRINTING APPARATUS

(76) Inventor: Noriyuki SAI, Kanagawa (JP)

(21) Appl. No.: 13/526,702

(22) Filed: Jun. 19, 2012

(30) Foreign Application Priority Data
Jul. 5, 2011 (JP) 2011-149537

(51) Int. Cl. G06F 15/00; G06K 15/02

(52) U.S. Cl. 358/1.13; 358/1.14

(57) ABSTRACT

A printing apparatus management apparatus which is communicatively connected to multiple printing apparatuses and multiple information processing apparatuses and which controls a state for each of the multiple printing apparatuses to restrict the number of multiple printing apparatuses used is disclosed. The printing apparatus management apparatus includes a receiving unit; a calculating unit; a recording unit; an examining unit; a determining unit; a collecting unit; a decision unit which, while deciding to permit usage in order of a printing apparatus with a larger collection result of multiple printing apparatuses within a range not exceeding a predetermined maximum consumed power, decides to set a printing apparatus for which usage is not permitted in a usage prohibition state in which only power needed for communicating with a printing management apparatus is supplied; and a transmitting unit.

### TECHNICAL FIELD

The present invention relates to printing apparatus managing apparatuses and printing apparatuses for reducing consumed power.

### BACKGROUND ART

For example, many printing apparatuses (image forming apparatuses; for example, a copying machine, a printer, an MFP: multi function peripheral, etc.) may be in operation in an office. When all of these printing apparatuses simultaneously perform image forming operations (copying and printing), a peak of the consumed power becomes large. Therefore, depending on the power supplying status, a control to restrict the number of printing apparatuses which can operate simultaneously (a control of the number of the printing apparatuses used) is needed. Such a control is performed in ever-changing operating conditions of a PC (a personal computer, an example of an information processing apparatus) connected with a printing apparatus in an information processing system or an information processing apparatus.

As an example of controlling the number of the printing apparatuses used, there is a method in which the necessity of individual printing apparatuses is not determined (a first control method). With this method, when it becomes likely that a total of consumed power of all the printing apparatuses exceeds a predetermined threshold value, the excess printing apparatuses are transferred to an energy saving mode (an energy saving wait state). The first control method is disclosed in Patent documents 1 and 2, for example.

However, in the energy saving mode, in order to maintain a preheat state, an engine operates and a controller operates to some extent, causing power consumption. Moreover, in the energy saving mode, it is possible to easily return to a normal mode (a normal wait state) when a user touches an operating panel, etc., possibly causing the power consumption.

Thus, it is difficult to say that a proper control may be achieved with the first control method.

Thus, as a different example of controlling the number of printing apparatuses used, there is a method which determines the necessity of individual printing apparatuses (a second control method) for the control. In this method, the necessity of individual printing apparatuses is determined based on predetermined viewpoints, operating permissions are provided in order of descending necessity of printing apparatuses, and, when it is determined that a consumed power total of the printing apparatuses for which the operating permissions are provided may exceed a predetermined threshold, usage of the other printing apparatuses is prevented.

In the second control method, an example of the viewpoints for determining the necessity of the individual printing apparatuses includes “operating conditions of staff members and the PC around the printing apparatus”. In other words, this is a method of determining the necessity of the printing apparatus based on the number of staff members and the number of PCs which operate around a predetermined printing apparatus (operating condition criteria determining method). With this method, it is measured real-time as to whether many staff members and PCs operate around the printing apparatus to determine the necessity of the printing apparatus. According to this method, conditions, etc., of the office are immediately reflected to the operating conditions of the printing apparatus, so it is believed that the necessity of the printing apparatus may be determined relatively accurately if the operating conditions of the staff members and the PCs around the printing apparatus may be measured accurately.

### PATENT DOCUMENT

Patent document 1 JP2009-065408A
Patent document 2 JP3512016B

However, with the above-described operating condition criteria determining method, it is necessary to measure a position of a staff member and a PC in real time using an IC tag or wireless communications, for example, in order to grasp an operating condition of the staff member and the PC. In other words, there is a problem that, in order to newly introduce facilities (devices or systems) for position measurement, there is an added cost and burden.

### DISCLOSURE OF THE INVENTION

In light of the circumstances as described above, an object of the present invention is to provide a printing apparatus managing apparatus and a printing apparatus which make it possible to determine between a low necessity printing apparatus, and a high necessity printing apparatus without the need for newly introducing facilities for determining the necessity of the printing apparatus in controlling the number of the printing apparatuses used, and which make it possible to reduce consumed power of the low necessity printing apparatus to a level lower relative to an energy saving mode while preferentially operating a high necessity printing apparatus.

According to an embodiment of the present invention, a printing apparatus management apparatus which is communicatively connected to multiple printing apparatuses and multiple information processing apparatuses and which controls a state for each of the multiple printing apparatuses to restrict the number of multiple printing apparatuses used is provided, the printing apparatus management apparatus including a receiving unit which, after receiving, from a predetermined information processing apparatus, a printing request including a printing start time which is a time at which printing execution is directed in the information processing apparatus, receives information indicating user authentication time as time at which user authentication was performed in the printing apparatus connected to the information processing apparatus from the printing apparatus; a calculating unit which calculates as a printing time a difference between the printing start time and user authentication time; a recording unit which collates the printing time, the printing start time, information identifying the information processing apparatus, and information identifying the printing apparatus and records the collated results as a printing time database; an examining unit which examines whether the multiple information processing apparatuses are in operation and, as a result, obtains information identifying the information processing apparatuses in operation; a determining unit which determines, for each one of records in the printing time database, whether information identifying the information processing apparatus that is included in the record applies to the information identifying the information processing apparatus in operation, whether the printing starting time included in the record is within a predetermined period, and whether the printing time included in the record is within a predetermined time, and which performs the determining for all of the records; a collecting unit which, when results of the determining for the one record are all yes, adds a predetermined point to information identifying a printing apparatus included in the record, and collects the added point for each information set identifying a printing apparatus recorded in the printing time database; a decision unit which, while deciding to permit usage in order of a printing apparatus with a larger collection result out of the multiple printing apparatuses within a range not exceeding a predetermined maximum consumed power, decides to set a printing apparatus for which usage is not permitted to a usage prohibition state in which only power needed for communicating with the printing management apparatus is supplied; and a transmitting unit which transmits a notification for controlling a printing apparatus based on decision results in the decision unit to the multiple printing apparatuses.

The present invention makes it possible to determine between a low necessity printing apparatus, and a high necessity printing apparatus without the need to newly introduce facilities for determining the necessity of the printing apparatus in controlling the number of the printing apparatuses used, and to reduce consumed power of a low necessity printing apparatus to a level lower relative to an energy saving mode while preferentially operating a high necessity printing apparatus.

### BRIEF DESCRIPTION OF THE DRAWINGS

Other objects, features, and advantages of the present invention will become more apparent from the following detailed descriptions when read in conjunction with the accompanying drawings, in which:

FIGS. 1A and 1B are block diagrams, respectively showing hardware and software configurations of a management server according to one embodiment of the present invention;

FIGS. 2A and 2B are diagrams which explain an example of a method for a management server to determine usage prohibition/permission for a printer according to one embodiment of the present invention;

FIG. 3 is a diagram showing an example of state transitions of the printer according to one embodiment of the present invention;

FIG. 4 is a flowchart illustrating an example of an overall operation of the management server according to one embodiment of the present invention;

FIG. 5 is a sequence chart illustrating an exemplary operation of a PC, a management server, and a printer according to one embodiment of the present invention;

FIG. 6 is a diagram which explains a detailed example of a printing start time recording process and a printing time information recording process of the management server according to one embodiment of the present invention;

FIG. 7 is a diagram which explains a detailed example of a printer usage prohibition/permission setting operation of the management server according to one embodiment of the present invention;

FIG. 8 is a sequence chart illustrating an exemplary operation of the PC, the management server, and the printer according to a variation 1 of one embodiment of the present invention;

FIG. 9 is a diagram which explains a detailed example of a printer usage prohibition/permission setting operation of the management server according to the variation 1 of one embodiment of the present invention;

FIG. 10 is a diagram which explains a detailed example of a process of reflecting into a priority of presence/absence of scanning/copying of the management server according to the variation 1 of one embodiment of the present invention;

FIG. 11 is a diagram which explains an exemplary calculation of printing time information of the management server according to a variation 2 of one embodiment of the present invention;

FIG. 12 is a flowchart illustrating an example of an overall operation of the management server according to a variation 3 of one embodiment of the present invention;

FIG. 13 is a diagram showing an example of dividing usage permission/usage prohibition states among the respective printers that is determined by the management server according to a variation 4 of one embodiment of the present invention;

FIG. 14 is a diagram showing an example of the state transitions of the printer according to the variation 4 of the one embodiment of the present invention; and

FIG. 15 is a diagram which explains a detailed example of a printer usage prohibition/permission setting operation of the management server according to the exemplary variation 4 of one embodiment of the present invention.

### BEST MODE FOR CARRYING OUT THE INVENTION

Below, embodiments of the present invention are explained in detail with reference to the drawings. Below a printing apparatus is referred to as “a printer”. Thus, “the printer” may mean not only a separate printer for performing a printing (print) process, but also may mean an image forming apparatuses such as a copying machine, an MFP, a LP (laser printer), etc.

The present embodiment has the following features with respect to a printing apparatus management server (one example of a printing apparatus management apparatus of the present invention; below simply called “a management server”) which restricts the number of units used by controlling usage prohibition/permission for each printer in order to reduce total consumed power of multiple printers present in the office, etc.

In other words,

(1) As management states of the management server, there a normal management time and a low power management time; when printing from a PC occurs in the normal management time, “time” from printing start of the PC to placing over an authentication card reader of the printer is recorded.

(2) In the low power management time, for all PCs operating in an office, the management server examines the number of PCs in which printing occurred in a specific “time” within a specific period in the past, and operates printers (permits use thereof) preferentially for a case of the number of PCs being larger, which case is estimated to have a larger likelihood of the PCs operating in the vicinity of the printers, operating the maximum number of printers within a range in which total consumed power does not exceed a specified value and preventing use of the other printers. In this way, in the present embodiment, there is no need to newly introduce facilities for determining the necessity of a printer, making it possible to determine a high necessity printer and a low necessity printer. Thus, it leads to reduction in cost and time associated with the introduction of such facilities.

(3) When there exists a mix of an MFP and an LP (laser printer) as multiple printers, the management server is to permit using at least one unit each of the MFP and the LP. The reason is that, when printers for which usage is permitted are all LPs (with no MFP operating), it becomes impossible to perform copying or scanning; while, when the printers for which usage is permitted are all MFPs, it becomes impossible to print from the PC when all the MFPs are used for scanning or copying.

(4) A printer for which usage prevention is ordered from by management server stops all power supplying (i.e., to a printer and a scanner engine, a controller board body, an operating panel, etc.), except to a communications device for receiving a “usage permission notification”, which is sent from the management server. In this way, in the present embodiment, consumed power is reduced to a minimum by stopping all power supplying to the engine, the controller, and the operating panel. In this way, the consumed power is reduced relative to the time of the energy saving mode (it requires a cold start at activating time, so that activating takes time, but a priority is placed on reducing consumed power.) Moreover, in the present invention, power supplying to the operating panel is stopped, making it possible to prevent a user from operating the operating panel to simply cause a return to a normal mode and to maintain a state in which consumed power is reduced to a minimum.

The features of the present embodiment are described in detail using specific examples below.

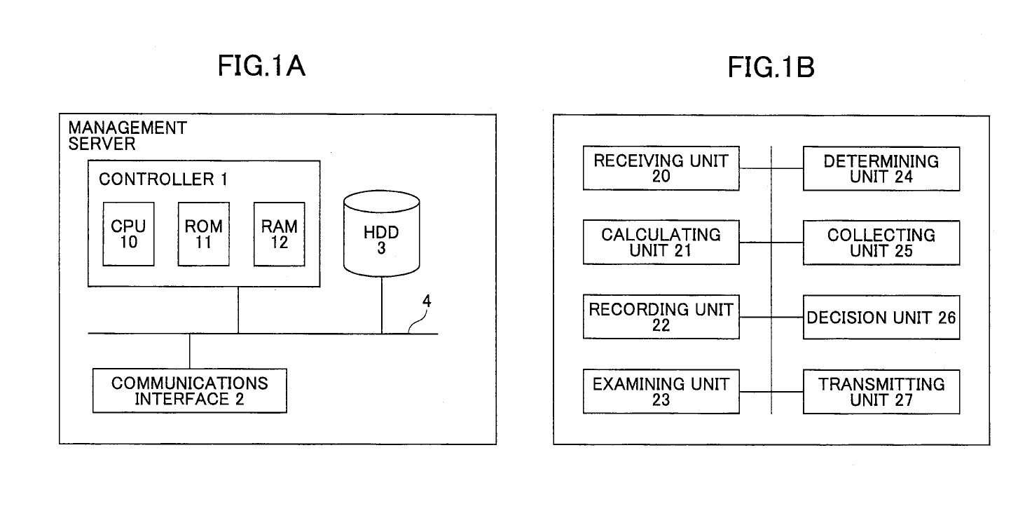

FIG. 1A is a diagram illustrating a hardware configuration of a management server according to one embodiment of the present invention. As shown in FIG. 1A, the management server includes a controller 1, a communications interface 2, a HDD (hard disk drive) 3, and a bus line 4.

The controller 1 controls the process of the whole management server. The controller 1 is internally configured with a CPU (central processing unit) 10; a ROM (read only memory) 11, which stores, in advance, fixed data such as a program, etc., which control the CPU 10; and a RAM (random access memory) 12, which forms an area in which various data are stored temporarily.

The communications interface 2, which is controlled by the controller 1, communicates with external apparatuses (such as below-described PCs and printers) of the management server. The communications interface 2 can also be configured with an Ethernet (registered trademark) interface, an IEEE 1284 interface, or a different interface, for example.

In the HDD 3, writing and reading of various data sets are conducted through a control of the controller 1.

For the bus-line 4 for electrically connecting the controller 1, the communications interface 2, and the HDD 3, an address bus, a data bus, etc., may be used, for example.

Next, functions which the management server have according to the present embodiment are described using FIG. 1B. FIG. 1B is a functional block diagram illustrating an exemplary configuration of software of the management server. As shown in FIG. 1B, the management server includes a receiving unit 20, a calculating unit 21, a recording unit 22, an examining unit 23, a determining unit 24, a collecting unit 25, a decision unit 26, and a transmitting unit 27.

The receiving unit 20 receives various information sets and notifications from multiple PCs and multiple printers connected to the management server. What are received includes a printing request notification from a PC; a most recent printer operating condition request from the PC; a scanning or copying execution notification and a printing execution notification from a printer; information on time at which a card is placed over the printer and a user ID from the printer (these notifications and information sets are described later). The receiving unit 20 is realized with the above-described communications interface 2.

The calculating unit calculates a difference between a time at which an execution of printing is directed on a PC (for example, a below-described printing start time) and a time at which a user causes an authentication card to be read by a printer connected to the PC (for example, a below-described time which the card is placed over the printer) as a “printing time”. Moreover, the calculating unit calculates a printing time determined by the determining unit 25 based on a printing time which belongs to a range in which printing frequency is at least a specific value within a certain period recorded by the recording unit 22 (below-called a variation 2). The calculating unit is realized by the controller 1.

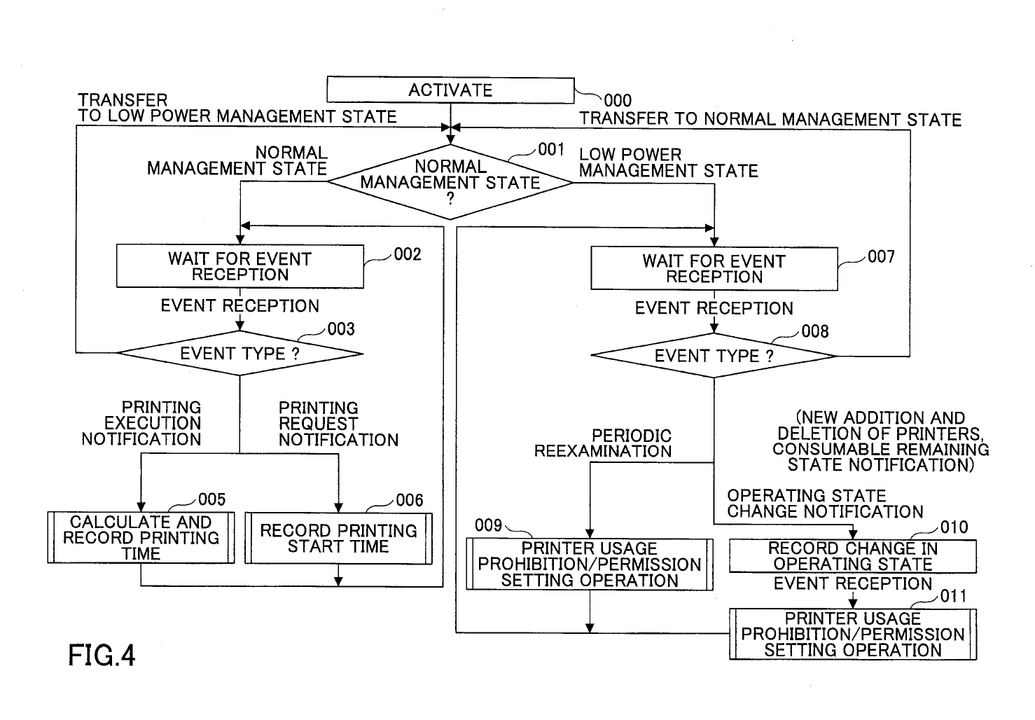

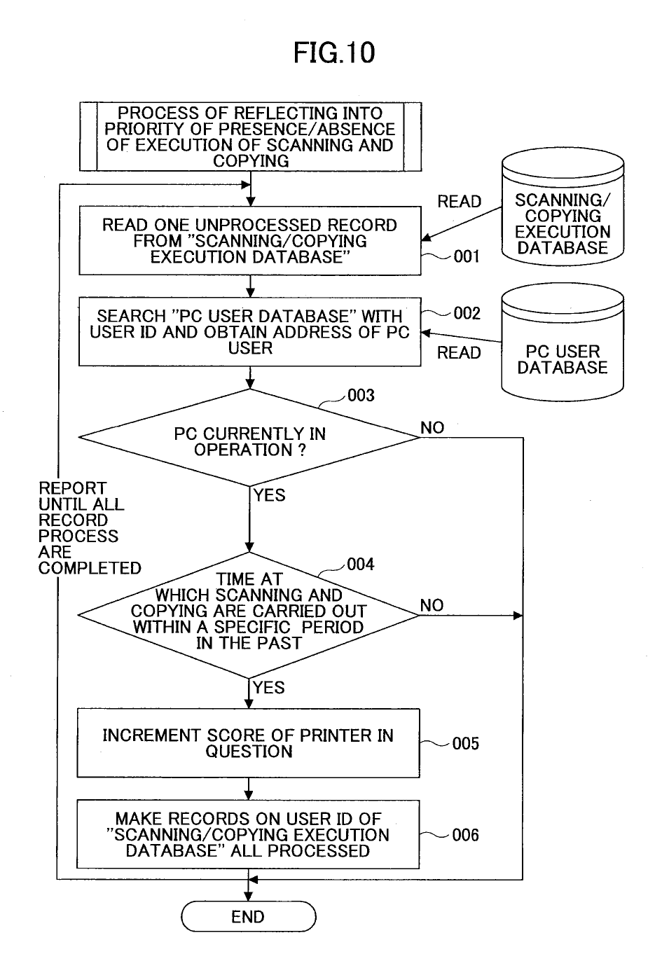

In the recording unit 22, various information sets are collated to record them as a database. Where to be recorded may be a management server itself or a different apparatus (for example, a database server) which can communicate with the management server. The recording unit 22 performs recording of a temporary job information database, a printing time database, a scanning/copying execution database, and a PC user database (details of the respective databases are described below), for example. Moreover, the recording unit 22 records a change of the printer operating state (010 of below-called FIGS. 4 and 10). Furthermore, the recording unit 22 records printing times calculated in the calculating unit 21 in time series (below-described variation 2). The recording unit 22 is realized by the controller 1 (when a recording destination is the management server itself, the HDD 3 is also included).

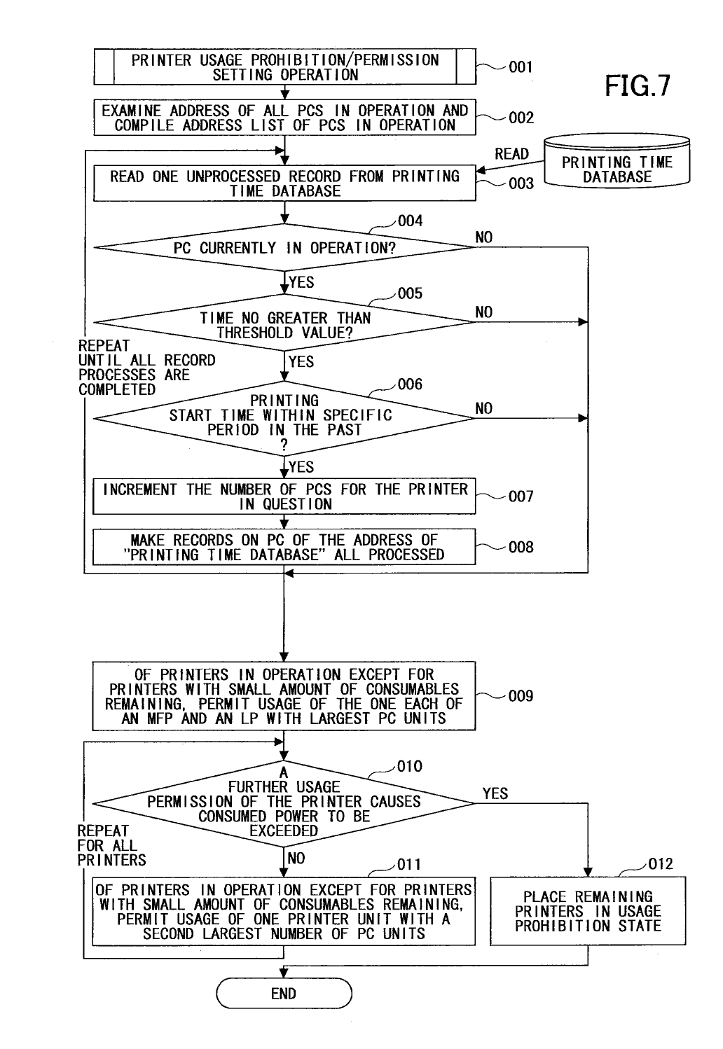

The examining unit 23 communicates with multiple PCs to examine whether the multiple PCs are in operation, and, as a result of the examination, obtains an address of a PC which is in operation and creates an address list (see 002 in FIGS. 7, 9, and 15). The examining unit 23 is realized with the controller 1 and the communications interface 2.

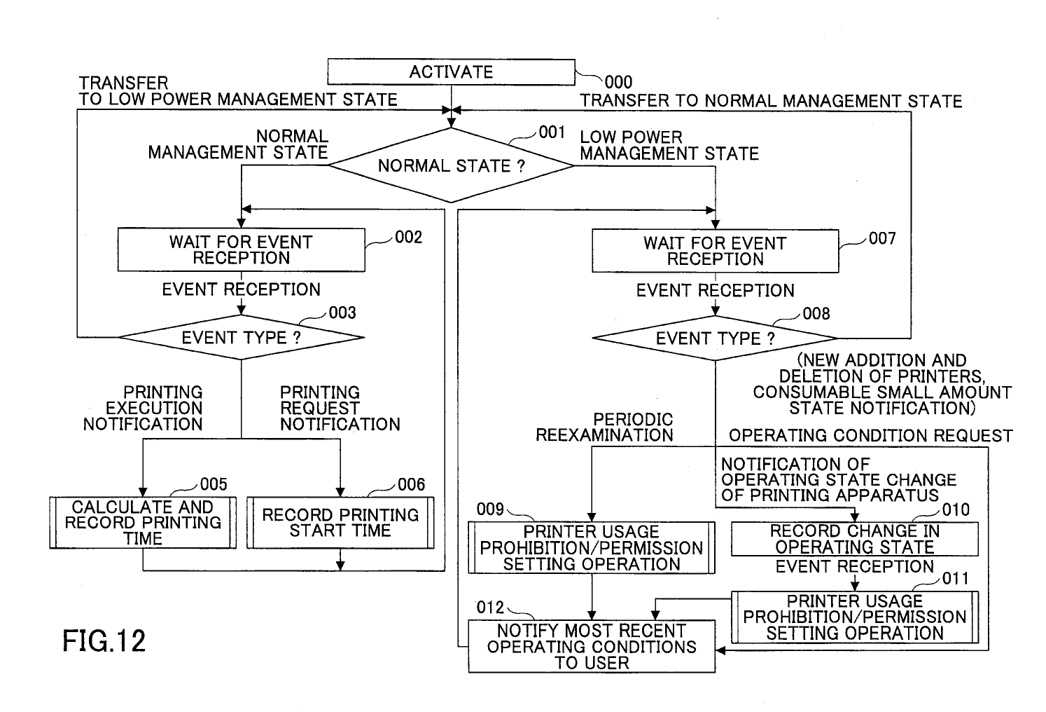

The determining unit 24 performs various determinations based on information and notification received from the receiving unit 20 and recording by the recording unit 22. While the details are described below, the determinations includes a determination of a state of a printer (below-described 001 in FIGS. 4 and 12); a determination of a type of an event (below-described 003 and 008 in FIGS. 4 and 12); respective determinations in a printer usage prohibition/permission setting operation (below-described 003-006 and 010 in FIGS. 7, 9, and 15); respective determinations in a process of reflecting into a priority the presence/absence of scanning/copying executions (001-004 in FIG. 10), etc. The determining unit 24 is realized by the controller 1.

The collecting unit 25 collects points (for example, below-described score and number of PC units) based on results of determining in the determining unit 24. Examples of collecting include collection (007 and 008 in below-described FIGS. 7, 9, and 15) in a printer usage prohibition/permission setting operation, collection in a process of reflecting into a priority the presence/absence of scanning/copying execution (005 and 006 in FIG. 10), etc. Collection results are handled by the below-described decision unit 26 as what shows the priority (necessity) of the respective printers. The collecting unit 25 is realized by the controller 1.

Based on the collection results of the collection unit 25, the decision unit 26 decides whether usage of the respective printers is permitted or prevented within a range not exceeding predetermined maximum consumed power. More specific processing examples include decisions in printer usage prohibition/permission setting operation (009, 011, and 012 in below-described FIGS. 7, 9, and 15). The decision unit 26 is realized by the controller 1.

The transmitting unit 27 transmits various information sets and notifications to multiple PCs and multiple printers connected to the management server. For example, a notification (a control signal) for controlling printers based on decision results in the decision unit 26 is transmitted to the respective printers (below-described 011 and 012 in FIGS. 7, 9, and 15). The printer which received the notification turns to a normal management state or an energy saving state if usage is permitted and to a usage prohibition state A or B if usage is prevented (details of the respective states are described below). The transmitting unit 27 is realized with the communications interface 2. Moreover, the transmitting unit transmits, to the PC, most recent operating conditions of the respective printers that reflects decision results by the decision unit 26 (below-described 012 in FIG. 12).

While an operating entity is described as “a management server” in a below-described explanation of the management server operation, the operation is realized by the above-described hardware of FIG. 1A and software of FIG. 1B cooperating with each other.

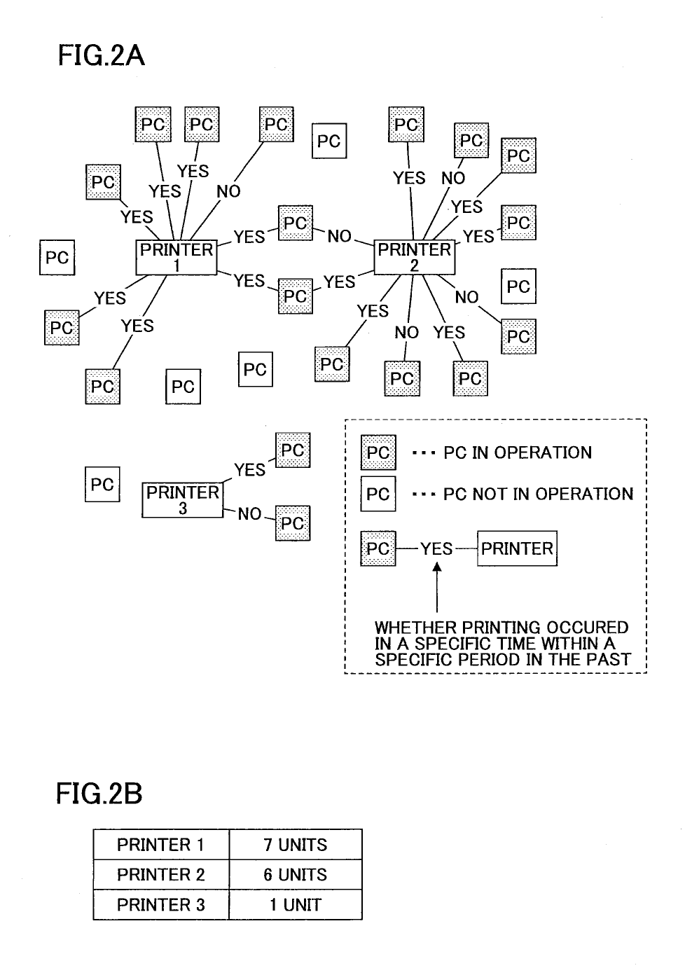

FIGS. 2A and 2B are diagrams which explain an example of a method for the management server to determine usage prevention/permission of printers in a low power management state.

For example, suppose there exist multiple printers and PCs (an example of information processing apparatus) as shown in FIG. 2A in the office, etc. In the example in FIG. 2A, multiple printers controlled by the management server includes three units 1 to 3. Moreover, while not shown in FIG. 2A, the management server is connected to and can communicate with each PC and each printer.

For each of printers 1-3, the management server (not shown) collects whether printing occurred in a specific time within a specific period in the past with the respective PCs based on past recordings (details are below described) collected from the respective PCs in advance. In an example of FIG. 2A, a PC and a printer which are linked by a recitation “yes” show that printing occurred in a specific time within a specific period in the past.

Collecting the PCs in an example in FIG. 2A yields what is shown in FIG. 2B. The printer 1 is most linked, while the printer 3 is least linked. Here, within a range that maximum consumed power does not exceed a specific value (predefined value), usage of a printer with the most collected number of PCs is preferentially permitted, while usage of the other printers is prevented. For example, in an example in FIG. 2B, the management server permits usage in the order of a printer 1, 2, and 3. Here, for example, permitting usage of up to the printer 3 causes the maximum consumed power to exceed a specified value, while when permitting usage of up to the printer 2 causes the maximum consumed power to not exceed the specified value, the management server permits usage of the printer 1 and 2 and prevents usage of the printer 3.

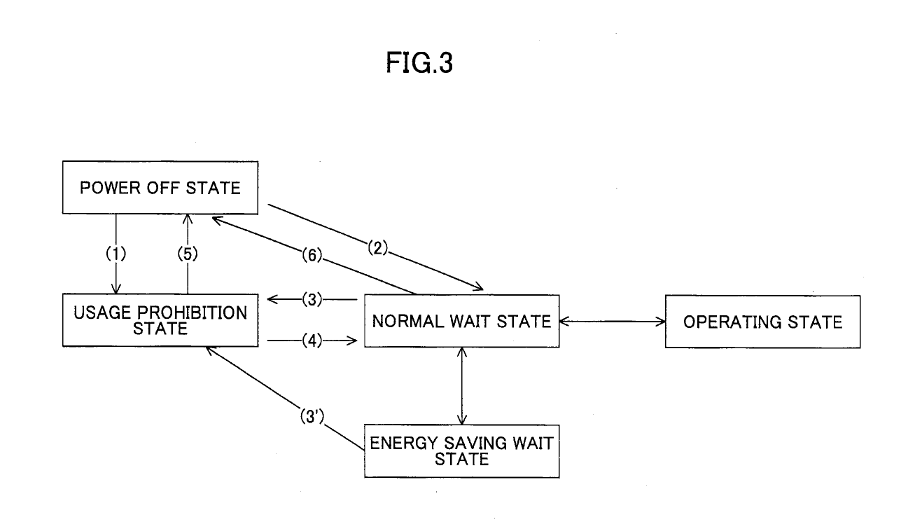

FIG. 3 is a diagram which explains an example of state transitions of a printer according to the present embodiment.

The printer, usage of which is controlled by the management server, undergoes state transitions in FIG. 3. When a user turns on a main power supply when a power supply is off, inquiries (communications) are made of the management server. As a result, when it is to be transferred to a usage prohibition state, the printer turns to the usage prohibition state (1), while, when it is to be transferred to a normal wait state, the printer turns to the normal wait state (2). When printing does not occur for a specific time after transferring to the normal wait state, the printer turns to an energy saving wait state. Moreover, when printing is directed within a specific time after transferring to the normal wait state, the printer turns to an operating state.

Here, the power supply off state means a state in which a main power supply of the printer is turned off. Moreover, the normal wait state, which may be called a normal mode or a normal management state, means a state in which a user may start printing immediately. Furthermore, the energy saving wait state, which is also called an energy saving mode or a low-power management state, means a state in which power supplying to those other than an engine, a controller, and an operational panel is stopped. Moreover, the operating state means a state in which printing is being executed. Moreover, usage prohibition state is a state in which a minimum power supplying (supplying of power required to communicate with a management server) only is conducted, so that, in addition to stopping power supplying in the energy saving wait state, power supplying to the operating panel is also stopped. In other words, in the printer, the usage prohibition state means a state that consumed power is further reduced relative to the energy saving wait state and a state in which an operation by the user is not accepted.

When a usage prohibition state transfer notification is received from the management server due to a change in operating conditions in a normal wait state or in an energy saving wait state, the printer immediately prevents acceptance of new jobs (printing, scanning, copying, etc.), executes or disposes already-accepted jobs, and turns to the usage prohibition state (3) and (3′).

When a normal wait state transfer notification is received from the management server due to a change in operating conditions in the usage prohibition state, the printer turns to the normal wait state (4).

When the user turns off the main power supply in the usage prohibition state or the normal wait state, the printer turns to a power supply off state (5) and (6).

FIG. 4 is a flowchart showing an example of an overall operation of the management server of the present embodiment. When the management server is activated (000), it determines whether a printer is to be managed in a normal management state or a low power management state (001) to transfer to a required process (002 or 007). At a time of initial activation, a transfer is made to the normal management state (002).

When the printer is managed in the normal management state (001/normal management state), the management server waits for event reception (002). Here, it waits for reception of any one of a printing execution notification from a printer; a printing request notification from a PC; and a low power management state transfer notification from a printer. When the management server receives any one of the notifications, it determines the type thereof (003).

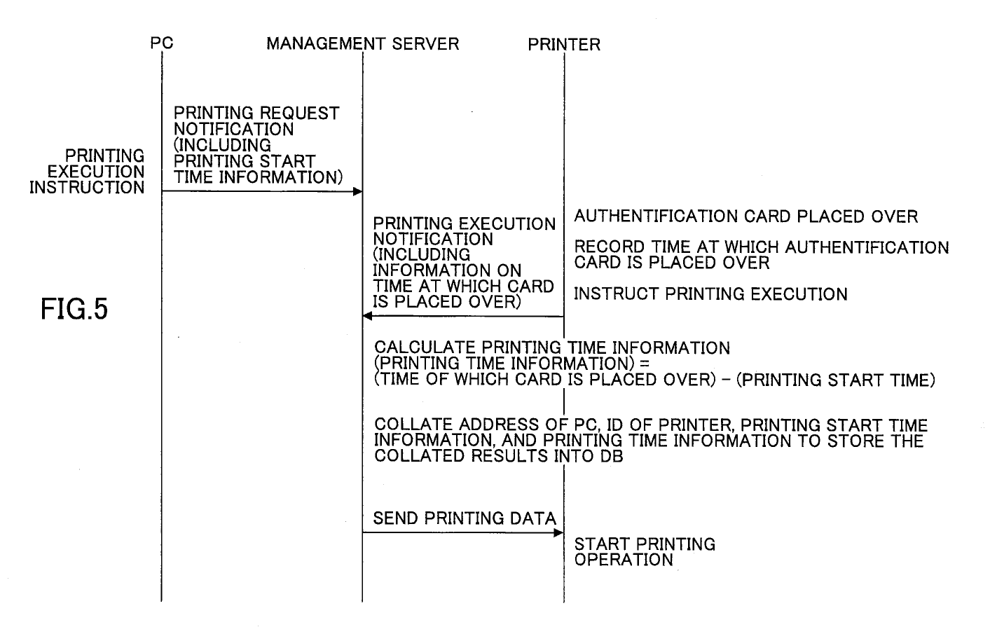

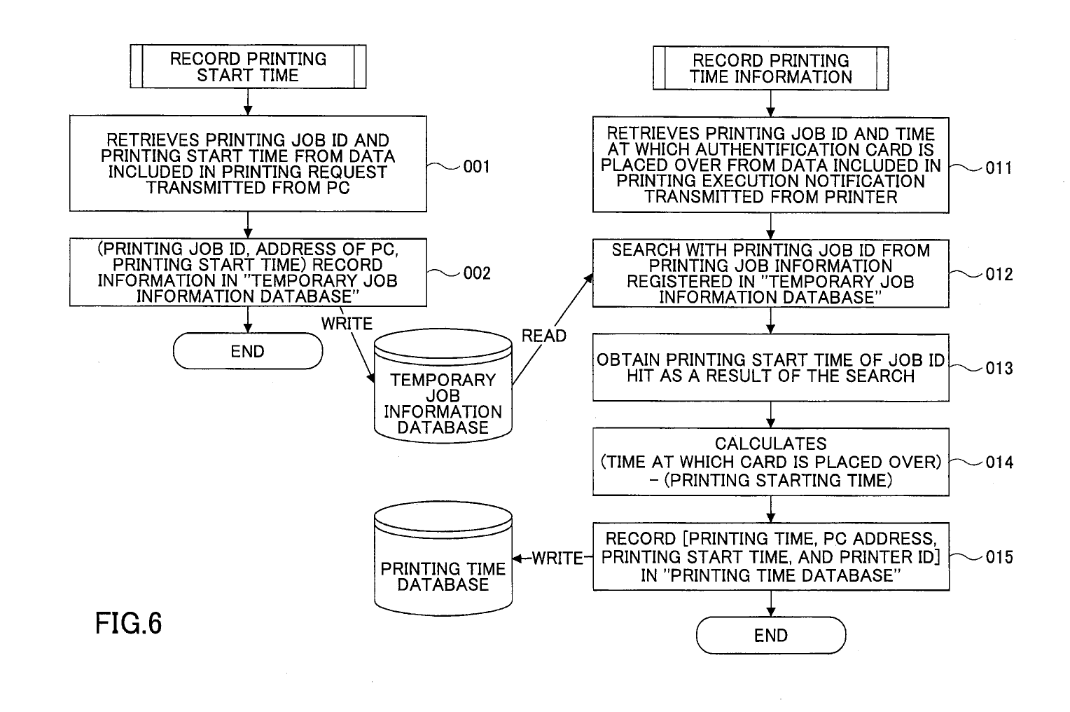

When the printing request notification is received from the PC (003/printing request notification), the management server records the printing start time (006), and waits for event reception again (002). The recording of the printing start time is described below using FIGS. 5 and 6.

When a printing execution notification is received from the printer (003/printing execution notification), the management server calculates and records printing time information, which is a difference between a time at which an authentication card is placed over the printer and the printing start time and waits for event reception (002). The calculating and recording of the printing start time is described below using FIGS. 5 and 6.

When a low power management state transfer notification is received from a printer (003/low power management state transfer), the management server changes to printer management in the low power management state (001/low power management state) and waits for event reception (007). Here, it waits for reception of any one of a periodic reexamination notification from a printer, an operating condition change notification from the printer, and a normal management state transfer notification from the printer. When the management server receives any one of the notifications, it determines the type thereof (008).

When the periodic reexamination notification is received from the printer (008/periodic review), the management server performs a printer usage prohibition/permission setting operation (009) which sets a printer for which usage is to be permitted/prevented based on an operating condition of a most recent PC (009), and waits for event reception again (007). Periodic reexamination periodically reexamines usage of which printer is to be permitted/prevented. An interval of periodic reexamination is predetermined. The printer usage prohibition/permission setting operation is described below using FIG. 7.

When an operating condition change notification (for example, printer power on (new addition), printer power off (deletion), remaining amount of consumables, etc.) of a printing apparatus is received from a printer (008/operating state change notification), the management server records a change of the operating state (010). Then, based on the most recent PC operating conditions, the management server performs a printer usage prohibition and permission setting operation which sets a printer for which usage is to be permitted/prevented (011) and waits for event reception again (007). The printer usage prohibition/permission setting operation is described below using FIG. 7.

When a normal management state transfer notification is received from the printer (008/normal management state transfer), the management server changes to printer management in the normal management state (001/normal management state) and waits for event reception (002).

Now, details of printing start time recording (006) and printing time information recording (005) in FIG. 4 are described using FIGS. 5 and 6.

FIG. 5 is a sequence chart showing an exemplary operation of a PC, a management server, and a printer.

When a printing execution instruction is accepted from a user, a PC transmits a printing request notification to the management server. In the printing request notification is included time (printing start time information) at which a user directs printing execution in the PC.

When the printing request notification is received, the management server retrieves the printing start time information to record the information.

In order to cause the printer to perform the printing directed in the above, an authentication card is placed over the printer. The printer records the time (the time at which the card is placed thereover). “Placing over” means the user places the authentication card in contact with an authentication card reader which is provided in the printer, or the user holds the authentication card close to the authentication card reader.

Then, when the user presses down a printing execution button, the printer transmits a printing execution notification to the management server. This printing execution notification includes the time at which the user placed the authentication card over the printer (information on time at which the card is placed over the printer).

When the printing execution notification is received, the management server retrieves the information on time at which the card is placed over the printer and calculates a difference with printing start time information which is recorded in advance. In other words, printing time information is calculated by subtracting the printing start time from the time at which the card is placed over the printer.

The management server collates the calculated printing time information; an address of a PC from which the printing request notification is transmitted (an example of identification information; a MAC address, for example); printing start time information included in the printing request notification; and an ID (an example of identification information; a MAC address, for example) of a printer from which the printing execution notification is transmitted to record the collated results to a database.

Then, the management server transmits printing data received with the printing request from the PC to the printer.

The printer executes printing of printing data received from the management server.

FIG. 6 is a diagram which describes details of the printing start time recording process and the printing time information recording process in an operational flow in FIG. 4. FIG. 6 shows FIG. 5 in further details.

(Printing Start Time Recording Process)

When the printing request notification is received which is transmitted from the PC, the management server retrieves a printing job ID and a printing start time (time at which the user pressed a printing execution button on the PC, for example) included therein (001).

The management server records the retrieved printing job ID and the printing start time and the address of the PC which sent the printing request notification as a record in “a temporary job information database” (002).

(Printing Time Information Recording Process)

When the printing execution notification sent from the printer is received, the management server retrieves the time at which the card is placed over the printer (e.g., the time at which the user caused the printer to read the authentication card) and the printing job ID included therein (011).

When the same ID as the printing job ID retrieved from the printing execution notification is searched for and found as a hit in a temporary job information database, the printing start time collated with the printing job ID is obtained (012, 013).

The management server calculates a difference (printing time) between a time at which a card is placed over the printer that is retrieved from the printing execution notification and the printing start time which is retrieved from the temporary job information database (014).

The management server records the calculated printing time; an address of the PC from which the printing request notification is sent (a PC address); a printing start time included in the printing request notification; and an ID of a printer from which the printing execution notification is sent, as a record, in “the printing time database” (015).

FIG. 7 is a diagram which explains details of the printer usage prohibition/permission setting operation in an operational flow in FIG. 4.

The management server communicates with all of the PCs in operation to obtain an address of the respective PCs and compile an address list of obtained addresses (002).

Next, the management server reads what corresponds to one record (printing time, PC address, printing start time, printer ID) from the printing time database (003).

Here, the management server determines whether the read PC address is in an address list, or whether a PC with a read PC address is currently in operation (004).

If the read PC address is not in the address list, the management server determines that the PC is currently not in operation (004/No) and transfers to the below-described process of 009. On the other hand, if the read PC address is in the address list, the management server determines that the PC is currently in operation (004/Yes) and transfers to the below-described process of 005.

Next, the management server determines whether the read printing time is less than or equal to a threshold value (005). The threshold value, which is a predetermined value (a specified value), is held in advance by the management server, or can be obtained by the management server from a different apparatus, etc., at the time of determining process of 005.

When the read printing time is not less than or equal to the threshold (005/No), the management server transfers to the below-described process of 009. On the other hand, when the read printing time is less than or equal to the threshold value (005/Yes), the management server transfers to the below-described process of 006.

Next, the management server determines whether the read printing start time is within a specific period in the past (006). The specific period, which is a predetermined value (a specified value), is held in advance by the management server, or can be obtained by the management server from a different apparatus, etc., at the time of determining process of 006.

When the read print starting time is not within the specified period in the past (006/No), the management server transfers to the process in the below-described process of 009. On the other hand, when the read printing start time is within the specified period in the past (006/Yes), the management server transfers to the below-described process of 007.

Next, if it is determined all Yes in 004, 005, and 006, the management server adds a numerical value “1” (an example of a point) as the number of PCs for a printer ID read (007).

Next, as a combination of the read PC address and the printer ID has been processed, the management server makes records of the PC addresses and the printer IDs all processed in the printing time database (for example, provide a flag indicating that they are all processed). (008)

The management server repeats the processes of 003-008 until all records of the printing time database are processed. In this way, as described in FIG. 1, the management server is to collect the number of PCs for which printing occurred in a specific time within a specific period in the past for each printer connected to a PC in operation.

When all records in the printing time database are processed, the management server permits usage of one each of the MFP and the LP with the most number of PCs collected from printers in operation (printer IDs which have undergone 007) except for printers with a small remaining amount of consumables (toner, for example) (009). In other words, the management server is to permit usage of one each of an apparatus (e.g., an MFP) which has scanning and copying functions and an apparatus (e.g., an LP) which has a print (printing) function.

Which printer has a small amount of consumables remaining is determined, for example, by the management server determining whether an amount of consumables remaining that is recorded in 010 in FIG. 4 (included in the operating state change notification) is no greater than a predetermined threshold value. The threshold value is also held in advance by the management server, or what the management server can obtain from a different apparatus, etc., at the time of the determining process. When the recorded amount of consumables remaining is no greater than the threshold value as a result of the determining, the management server removes the printer in question as a printer with a small amount of consumables remaining, and otherwise it does not remove the printer in question. The remaining amount of consumables that is recorded in 010 in FIG. 4 is included in the operating state change notification such that it is collated with a printer ID. Thus, the management server may be arranged to search a printing time database with a printer ID included in the operating state change notification as a key when the operating state change notification is received from a predetermined printer and to add a remaining amount of consumables when there was a hit.

Moreover, which printer is an MFP or an LP (the printer type) may be included in a printer ID in advance, so that the management server may identify it at the time of determining of 009, for example. Alternatively, information in which the printer ID is collated with the printer type information may be held by the management server or obtained by the management server from a different apparatus at the time of determining of 009.

Here, the management server determines whether a further usage permission of a printer causes the consumed power to exceed the predetermined threshold value (010). It is assumed that the management server holds in advance a power consumption value for each printer and for each threshold value, or can obtain the power consumption value from a different apparatus, etc., at the time of the determining process.

When not exceeded (010/No) as a result of the determining, the management server, of printers in operation except for a printer with a small amount of consumables remaining, permits usage of one printer unit with a second largest number of PCs collected (011).

In 011, if it is determined that usage for a printer which was in the usage prohibition state is permitted, the management server transmits a notification for transferring to a normal management state (or a low power management state) to the printer. The printer which received the notification is transferred to a normal management state (or a low power management state). On the other hand, when it is determined that usage of a printer in usage permitted state even up to then (a normal management state or a low power management state) is continuously permitted, the management server may or may not send a notification of usage permission to the printer.

The management server repeats 010-011 in the above for all printers (printer IDs which has undergone 007).

Then, when the consumed power exceeds the predetermined threshold value as a result of determining of 010 (010/Yes), the management server adjusts the remaining (not usage permitted) printers, including a printer for which usage has been permitted most recently, to a usage prohibition state (012). In other words, the management server transmits a notification for transferring to the usage prohibition state to a printer applicable. Upon receiving the notification, the printer is turned to a usage prohibition state. As described above, the usage prohibition state is a state (a state in which only power needed for communicating with the management server is supplied) in which consumed power is reduced further relative to a low power management state and is a state in which an operation by a user is not accepted.

The above-described management server according to the present embodiment is summarized below. At the time of the normal management state, the management server according to the present embodiment calculates and records “time” from a printing start instruction in a PC to when an authentication card is placed over a printer. Then, at the time of low power management, the management server preferentially operates those printers with many PCs in which printing occurred in a specific “time” within a specific period in the past out of PCs in operation then, which printers are estimated to have many PCs in operation in the vicinity thereof. Then, the management server causes a maximum number of printers to operate within a range such that total consumed power of the printers in operation does not exceed a specific value and causes usage of the other printers to be prevented.

Thus, for example, when the number of printers (printing apparatuses) to be used in an office, etc., is to be restricted in order to reduce power consumption, a high necessity printer such that many PCs operate in the vicinity of the printer may be estimated without using a special system or technology and the usage of the printer may be preferentially permitted.

Moreover, the management server according to the present embodiment notifies a printer to be usage prevented that the printer is to be transferred to a usage prohibition state. A printer which receives the notification is adjusted to a usage prohibition state, or in other words, to a state in which even an acceptance of an operation of a user is prevented (a state with consumed power which is low relative to an energy saving wait state), monitoring for a usage permission notification sent from the management server, and blocking all power supplying to printers and scanner engines except for communications, controllers except for communications devices, and devices such as an operating panel, etc.

Therefore, in the printer to be usage prevented, control from the management server is maintained while eliminating power consumption due to a wasteful activating operation by a user operation or a wait operation of various devices, making it possible to reduce consumed power to a required minimum, making consumed power less than an energy saving wait state.

Moreover, when there is a mix of MFP and LP as multiple printers, the management server according to the present embodiment causes at least one MFP and LP to operate. In other words, the management server permits usage of at least one each of an apparatus (e.g., an MFP) which has scanning and copying functions and an apparatus (e.g., an LP) which has a print (printing) function.

Thus, it is made possible to avoid a situation in which operating only the LP makes scanning and copying not possible, or operating only the MFP causes all MFPs to be used in scanning and copying, making printing from a PC not possible.

Below, a description is given with regard to respective variations of the present embodiment.

Variation 1

While, in the explanation of the embodiment, a priority on usage of the respective printers is calculated based on a number of PCs for which printing occurred in a specific time within a specific period in the past, it may be arranged to add the presence/absence of whether scanning or copying was done within a specific period in the past for each of the PCs in operation. Below, specifics of operations are explained.

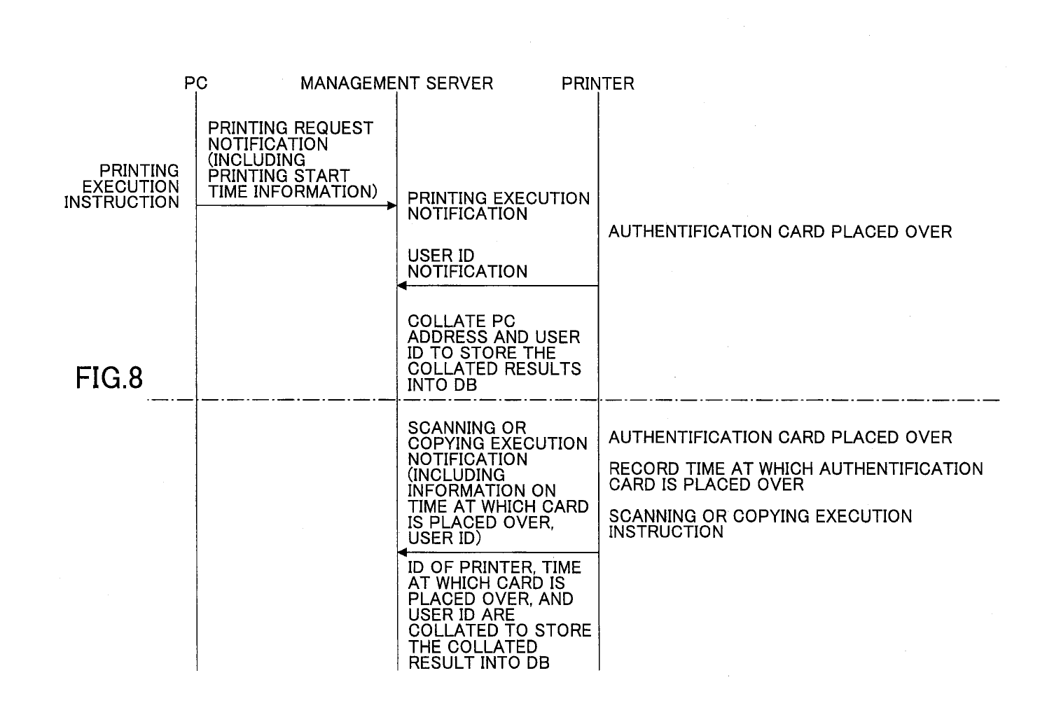

The operation according to the present variation is basically the same as the operation in FIG. 4 as described above. In the present variation, there are additions in FIG. 4 with respect to processes beyond 003 at the time of normal management state. This is described using FIG. 8.

Moreover, the upper side of the dashed line in FIG. 8 is explained. Similar to the explanation in FIG. 5, this sequence is an operation for a case in which a printing execution instruction is made in a PC. While an operation after transmitting a printing request notification from a PC to a management server is not shown in FIG. 8, an operation similar to an operation explained in FIG. 5 is performed. In other words, when the printing request notification is received from the PC, the management server retrieves and records printing start time information, and the user places the authentication card over the printer in order to cause the printer to execute the instructed printing. When the time then (the time at which the authentication card is placed over the printer) is recorded and the user presses down the printing execution button, the printer transmits a printing execution notification to the management server. Then, the management server retrieves the information on time at which the card is placed over the printer from the received printing execution notification and calculates a difference with printing start time information which is recorded in advance. The management server collates calculated printing time information; an address of a PC from which the printing request notification is transmitted; printing start time information included in the printing request notification; and an ID of a printer from which a printing execution notification is transmitted to record the collated results in a database (a printing time database).

In the present variation, the following operation is added to the above-described operation (the operation described in FIG. 5). When the user places the authentication card over the printer, the printer reads a user ID stored in the authentication card and transmits the read results to the management server. The user ID may be transmitted in a printing execution notification or may be transmitted alone separately from the printing execution notification.

When the user ID is received, the management server collates it with an address of a PC from which the printing request notification is transmitted to record the collated results in a database (a PC user database; an example of an information processing apparatus user database). The recording operation is done in 005 in FIG. 4. While it is explained herein that the user ID is to be recorded in a PC user database which is separate from the printing time database for convenience of explanations, it may be collated with the PC address to record the collated results in the printing time database.

Next, the lower side of the dashed line in FIG. 8 is explained. This sequence is an operation when a scanning or copying execution instruction is performed in a printer. When a user places an authentication card over a printer in order to cause the printer to perform scanning or copying, the printer reads the user ID stored in the authentication card and records the time then (the time at which the authentication card is placed over the printer). Thereafter, the above-described time is handled as a time at which execution of scanning or copying is directed (or a time at which scanning or copying is carried out). Then, when the user presses down the scanning or copying execution button, the printer transmits a scanning or copying execution notification to the management server. This scanning or copying execution notification includes information on time at which a card is placed over the printer and a user ID. The user ID may be transmitted solely to the management server without being included in the scanning or the copying execution notification.

Upon receiving the scanning or copying execution notification, the management server retrieves the information on time at which the card is placed over the printer and the card ID. Then, the management server collates the retrieved information on the time at which the card is placed over the printer and a user ID; and an ID of a printer from which a scanning or copying execution notification is transmitted to record the collated results in a database (scanning/copying execution database). The recording operation is performed in FIG. 4 as an operation parallel to 005 and 006 after it is determined to be “scanning or copying execution notification” in 003 in FIG. 4 (after recording, the process reverts to 002). While the feature of separate recording is explained such that the printing execution notification is recorded in a printing time database and the scanning or copying execution notification is recorded in a scanning/copying execution database, the two databases may be integrated. In such a case, it is necessary to distinguish between printing, scanning, and copying in one record.

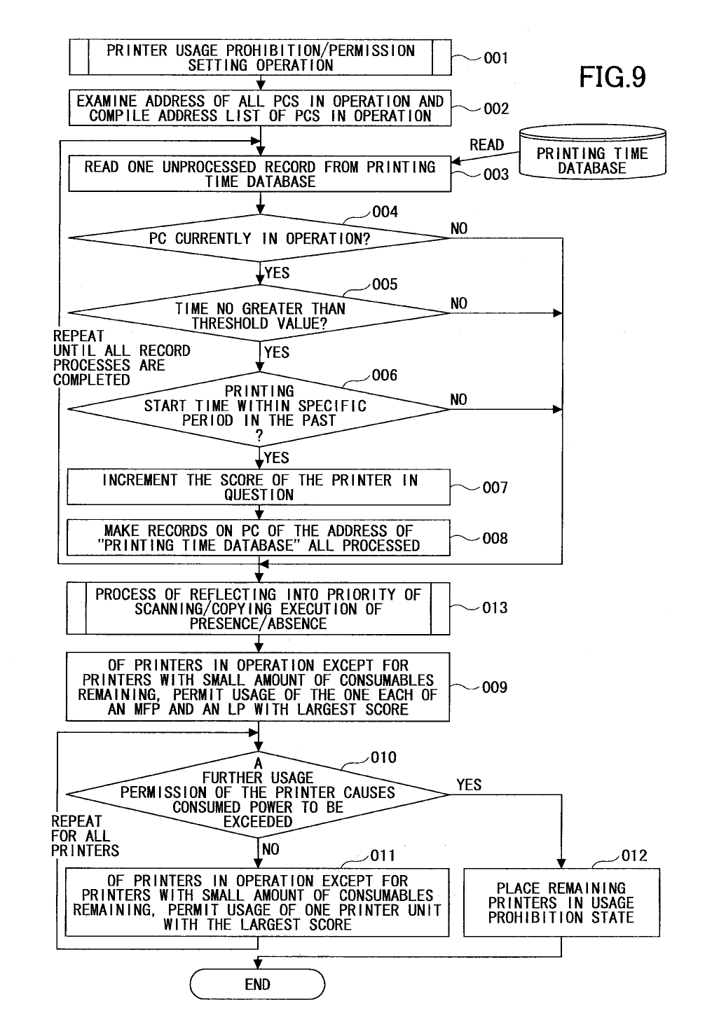

As described above, the management server of the present variation makes execution recording of not only printing but also scanning and copying before performing a printer usage prohibition/permission setting operation at the time of the low power management state. This is described using FIG. 9.

The flow in FIG. 9 is basically the same as the flow in FIG. 7 as described above. FIG. 9 differs from FIG. 7 in that “a score” is used as a value from which a usage priority is determined in 007, 009, and 011, and in that “a process of reflecting into a priority the presence/absence of scanning and copying execution” is added between 008 and 009. The “priority” is a degree with which usage is preferentially permitted and is synonymous to the “necessity”. Usage of a printer with a higher priority is preferentially permitted (does not become a usage prohibition state).

The “score” used in the present variation is a numerical value in which can be added the number of PCs in which printing occurred in a specific time within a specific period in the past in the printer as well as the number of PCs used by a user who performed scanning or copying during a specific period in the past. For example, when a certain user within a certain period in the past uses the own PC and the printer 1 to perform printing in a specific time, after which he performs copying in the printer 1 while the PC used by the user is the same one unit, collecting is done separately for printing and for copying. In collecting the score, as shown in FIG. 9, first the number of PCs for which printing occurred in a specific time within a specific period in the past in the printer in question is collected for each printer (007-008). Thereafter, in a process of reflecting a priority of the presence/absence of scanning and copying execution (013), the number of PCs used by the user that performed scanning or copying in a specific period in the past in the printer in question for each printer is added to the collection results of 007 and 008, and collected. A detailed example of 013 is explained using FIG. 10.

The management server reads one unprocessed record (a printer ID, information on time at which a card is placed over the printer, a user ID) from a scanning and copying execution database (001).

With the read user ID as a key, the management server searches the PC user database, and, when there is a hit, obtains a PC address which is collated with the user ID (002).

Here, the management server determines whether the read PC address is in an address list (created in 002 in FIG. 9), or whether a PC with the obtained PC address is currently in operation (003).

When the obtained PC address is not in the address list, the management server determines that the PC is not currently in operation (003/No), and returns to 001 until the processing for all records in the scanning and copying execution database is completed (when the processing for all records is completed, the series of processes are completed and transfers to 009 in FIG. 9). On the other hand, if the read PC address is in the address list, the management server determines that the PC is currently in operation (003/Yes) and transfers to the below-described process of 004.

Next, the management server determines whether the time (grasped as the time at which scanning and copying are carried out) indicated by the read information on the time at which the card is placed over the printer is within a specific period in the past (004). The specific period, which is a predetermined value (a specified value), is held in advance by the management server, or can be obtained by the management server from a different apparatus, etc., at the time of determining the process of 004.

When the read time at which the card is placed over the printer is not within a specific period in the past (004/No), the management server returns to 001 until the process for all records in the scanning and copying execution database is completed (when the process for all records is completed, the series of processes is completed and moves to 009 in FIG. 9). On the other hand, when the read time at which the card is placed over the printer is with the specified period in the past (004/Yes), the management server transfers to the below-described process of 005.

Next, if all Yes in the determining in 003 and 004, the management server adds a numerical value “1” (an example of a point) to a score (a score collected in 007-008) of the same ID as a read printer ID (005).

Next, as a combination of the user ID and the printer ID has been processed, the management server makes records of the user ID and the printer ID all processed in the scanning/copying execution database (for example, provide flags indicating that they are all processed) (006).

The management server repeats the processes of 001-006 until all records of the scanning and copying execution database are processed. In this way, the management server calculates the above-described score.

Using the score calculated in this way, the management server determines a printer for which usage is to be permitted in 009 and 011 in FIG. 9. Here, usage of a printer with the highest score is preferentially permitted.

As described above, according to the present variation, in grasping the operating conditions around a certain printer, not only presence/absence of printing but also presence/absence of scanning and copying are collected, making it possible to more accurately determine whether the necessity of the printer is high or low.

(Variation 2)

While, in the present embodiment, a priority of each printer is calculated from the number of PCs in which printing occurred in a specific time within a specific period in the past, for a more accurate estimation, a time (the above-described printing time) from a printing request in a PC to card authentication in a printer (placing of a card over the printer) is calculated based on a printing frequency of a specific period in the past may be calculated to determine the number of PCs within the time.

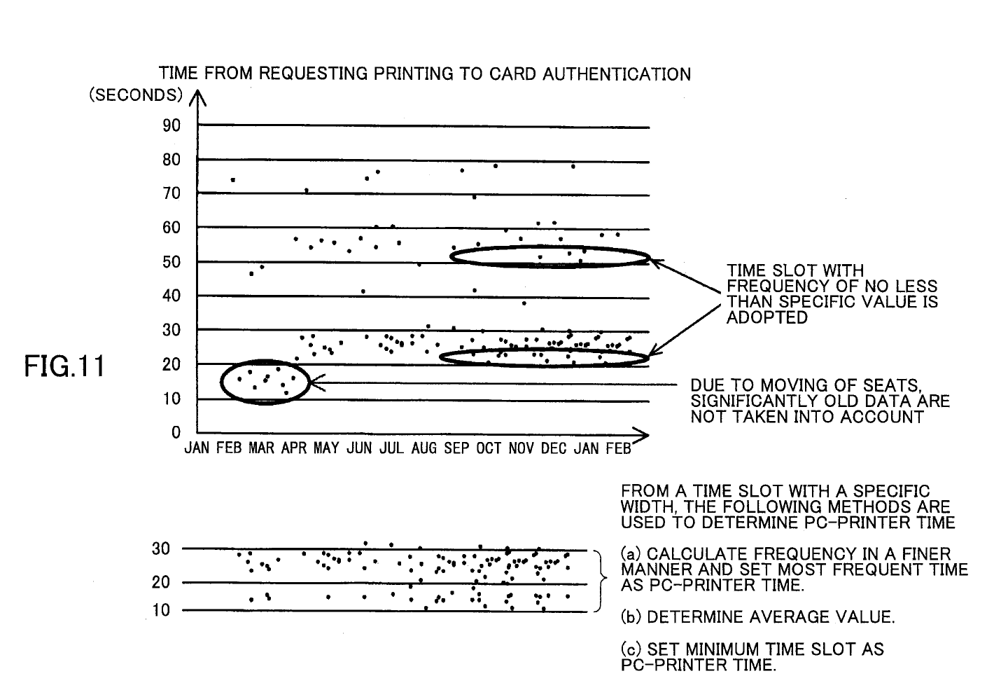

As shown in FIG. 11, for example, the management server maintains a log (a record) of a calculated printing time for each month. Then, the management server specifies a time slot with printing frequency within a specific period in the past of no less than a specific value from the log and uses the methods (a), (b), or (c) from the time slot to calculate a printing time to be adopted. For a log to be analyzed, most recent ones are to be used (around September to February in the example in FIG. 11) as follows:

(a) determine the maximum printing time within a specified time slot;

(b) determine an average value of printing time in a specified time slot; and

(c) determine the minimum printing time within a specified time slot.

Moreover, when there are multiple time slots in which printing frequency is greater than or equal to a specific value, the management server calculates a simple average of the time slots and calculates an expected value of frequency and time to determine the printing time.

As described above, printing time information (time from PC to printer) calculated in the present variation is compared with the threshold value in 005 in FIGS. 7 and 9.

As described above, according to the present variation, a printing time to be adopted is calculated based on a time slot with printing frequency of no less than a specific value and the number of PCs within the printing time may accurately determine whether the necessity of the printer is high or low.

(Variation 3)

The user may wish to know which printer is a printer for which usage is permitted and which printer is a printer for which usage is prevented by the management server. Thus, the management server may notify “the most recent operating conditions of the printer” to the user.

The operation of the present variation is shown in FIG. 12. FIG. 12 is basically the same as the flow in FIG. 4. It differs from FIG. 4 in that in 008 the event type is “operating conditions request” and that a process of “notifying the user of most recent operating conditions” in 012 is different from FIG. 4.

In other words, as shown in FIG. 12, the management server performs a printer usage prohibition/permission setting operation in 009 and 011, after which the most recent operating condition (which is a printer for which usage is permitted by the management server and which is a printer for which usage is prevented (012). Moreover, as shown in FIG. 12, if it is determined that the operating conditions request is received from a user PC, for example (008/operating conditions request), most recent operation conditions are reported to the requesting PC.

As described above, according to the present variation, the most recent conditions of the printer is reported to the user after the printer usage prohibition/permission setting operation, making it possible for the user to grasp which printer is in usage permission state and which printer is in usage prohibition state. Moreover, the user may request the management server when he wishes to know the most recent operating conditions of the printer to obtain the most recent operating conditions of the printer from the management server.

(Variation 4)

While the usage prohibition state of the printer is set to be a state in which power supplying is blocked except to devices necessary to receive a usage permission notification from the management server in the above-described embodiment, two types of usage prohibition states may be provided to shorten an activation time for transitioning from usage prevention to usage permission (normal management state).

For example, the two types below are provided.

Usage prohibition state A: a state in which all power supplying is prevented except for communications.

Usage prohibition state B: while usage is prevented, the printer and the scanner engine are set to be in a preheat wait state, and power therefor is supplied. In other words, a state in which only power required for preheat of the engine and power required for communications are supplied;

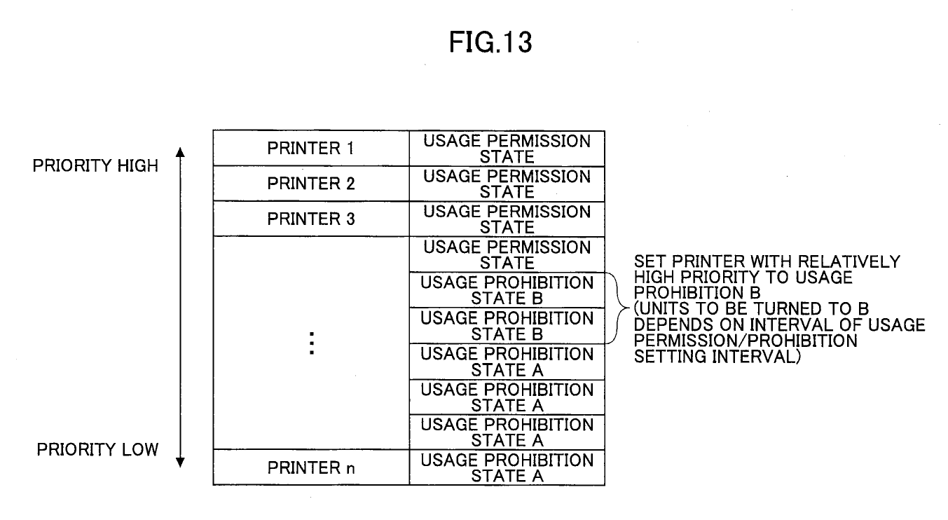

As described in FIGS. 7 and 9, when the printer is set to a usage prohibition state, as shown in FIG. 13, it may be arranged to perform a control such that a printer with a relatively high priority (for example, the number of PCs, score) is set to the usage prohibition state B as the likelihood is high that usage will be permitted in the future and a printer with a low priority is set to the usage prohibition state A. Moreover, it may be arranged to provide a control such that, when an execution interval of the printer usage prohibition/permission setting operation (periodic reexamination) is set short, the number of units of usage prohibition state B is increased, and when it is long, the number of units of usage prohibition state B is decreased (see FIG. 13).

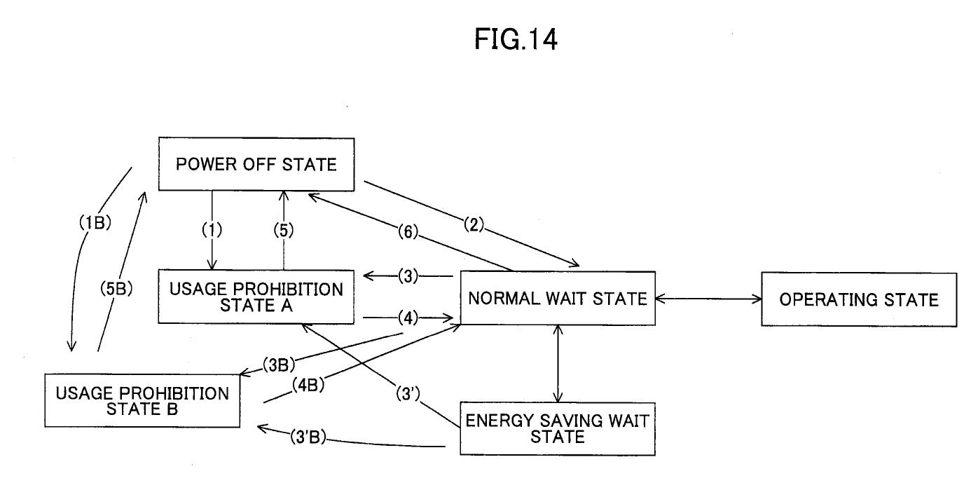

Here, an example of transition of printer states is shown in FIG. 14 when two types of usage prohibition states A and B are provided.

The printer for which usage is controlled by the management server undergoes state transition as shown in FIG. 14. When a user turns on a main power supply when a power supply is off, the printer sends an inquiry to the management server (the printer communicates to the management server). As a result, if a transfer is to be made to the usage prohibition state A, the printer transfers to the usage prohibition state A (1); if a transfer is to be made to the normal wait state, the printer transfers to the normal wait state (2); and, if a transfer is to be made to the usage prohibition state B, the printer transfers to the usage prohibition state B (1B). When printing does not occur for a specific time after transferring to the normal wait state, the printer turns to an energy saving wait state. Moreover, when printing is directed within a specific time after transferring to the normal wait state, the printer turns to an operating state.

When a normal wait state transfer notification is received from the management server due to a change in operating conditions in the usage prohibition state A, the printer turns to the normal wait state (4). Moreover, when the user turns off the main power supply in the usage prohibition state A or the normal wait state, the printer turns to a power supply off state (5) and (6).

When a notification to transfer from the management server to the usage prohibition state B arrives, the printer turns to the usage prohibition state B (3B) and (3′B).

When the usage permission notification is received from the management server in the usage prohibition state B, the printer returns to the normal wait state (4B).

When the user turns off the main power supply in the usage prohibition state B, the printer turns to a power supply off state (5B).

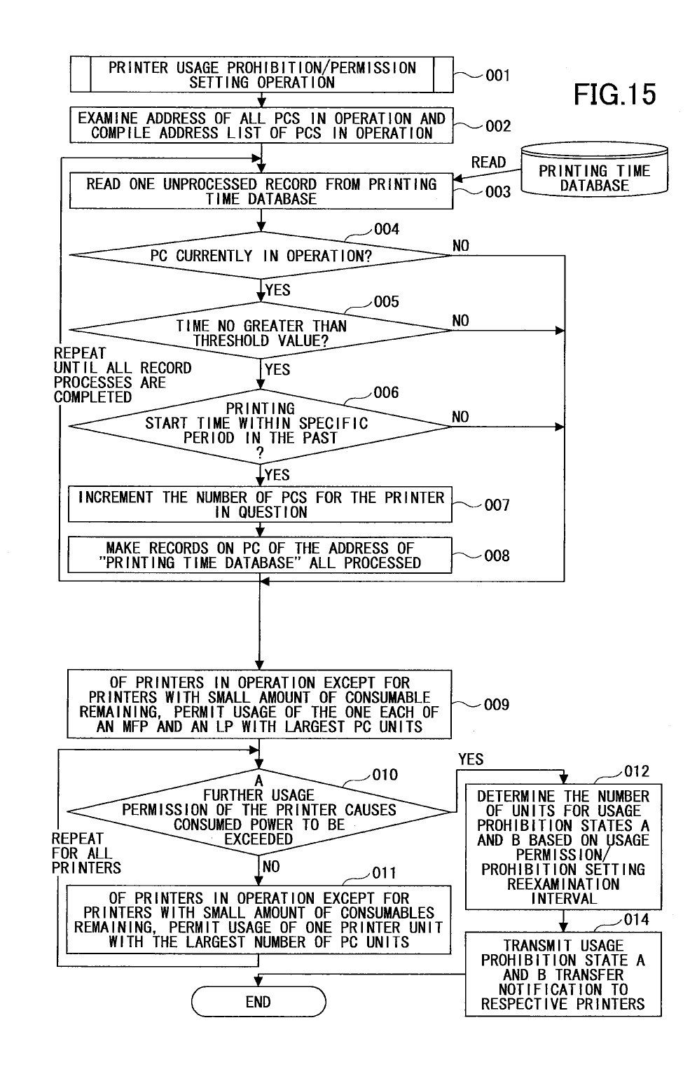

Next, a printer usage prohibition/permission setting operation of a management server according to the present variation is explained with reference to FIG. 15.

The flow in FIG. 15 is basically the same as the flow in FIG. 7. It is different from FIG. 7 in what is processed in 012 and in that the process in 014 is added after 012. In other words, when it is determined that the consumed power is exceeded with a further usage permission of the printer in 009 (009/Yes), the management server determines the number of units to be turned to the usage prohibition state A and B based on a predetermined periodic reexamination interval (012). Here, as shown in FIG. 13, for example, it is determined that only 2 units are set in the usage prohibition state B and the others are set in the usage prohibition state A.

Of printers to be usage prohibited, the management server sets a number of printers in the usage prohibition state B, the number of the printers being the number determined in 011 starting from one with a higher priority, and sets the others in the usage prohibition state A. For example, when there are printers 5 through n as printers for which usage is to be prevented, the high priority printers 5 and 6 are set in the usage prohibition state B and printers 7 through n are set in the usage prohibition state A. The management server transmits a notification to the respective printers such as to transfer to the usage prohibition state A or B (014). Upon receiving the notification, the respective printers are adjusted to the notified state (usage prohibition state A or B).

While an example is described in which 012-014 in FIG. 15 are applied in lieu of 012 in FIG. 7 in the above explanation, they may be applied in lieu of 012 in FIG. 9.

As in the above, according to the present variation, two types of usage prohibition states with different power supplying levels are provided, so that a high priority printer for which usage is prevented may be set to be turned to the usage prohibition state B or a state in which only power required for preheating of an engine and power required for communication are supplied, making it possible to shorten activation time for transitioning from usage prevention to usage permission (normal management state).

While the embodiment and variations thereof of the present invention are described above, it is not limited thereto, so that variations are possible without departing from the spirit thereof. The variations can be combined arbitrarily.

For example, the operation in the above-described embodiment can be executed using hardware, software, or a combined configuration of both.

When a process using software is executed, a program which has recorded a process sequence may be installed in a memory in a computer embedded in dedicated hardware for executing. Alternatively, a program may be installed into a general-purpose computer which can execute various processes.

For example, the program can be prerecorded in a hard disk or a ROM as a recording medium. Alternatively, the program can be stored (recorded) temporarily or permanently in a removable recording medium such as a semiconductor memory, a magnetic disk, a USB (universal serial bus), a DVD (digital versatile bus), an MO (magneto optical) disk, and a CD-ROM (compact disc read only memory). Such a removable recording medium can be provided as so-called package software.

The program may be installed into the computer from the removable recording medium as described above, or may be wirelessly transferred from a download site to a computer. Moreover, it may be transferred in a wired manner to a computer via a network such as the Internet and the LAN (local area network). In the computer, a program transferred can be received and installed in a recording medium such as an installed hard disk, etc.

Moreover, the program can be constructed such that it is executed in time sequence according to the process operations described in the above embodiment or executed in parallel or individually as required, or according to processing capabilities of the apparatus which executes the process.

The present application is based on Japanese Priority Application No. 2011-149537 filed on Jul. 5, 2011, the entire contents of which are hereby incorporated by reference.

1. A printing apparatus management apparatus which is communicatively connected to multiple printing apparatuses and multiple information processing apparatuses and which controls a state for each of the multiple printing apparatuses to restrict the number of multiple printing apparatuses used, the printing apparatus management apparatus comprising:
a receiving unit which, after receiving, from a predetermined information processing apparatus, a printing request including a printing start time which is a time at which printing execution is to be started in the information processing apparatus, receives information indicating user authentication time as a time at which user authentication has been performed in the printing apparatus connected to the information processing apparatus from the printing apparatus;
a calculating unit which calculates as a printing time a difference between the printing start time and the user authentication time;
a recording unit which collates the printing time, the printing start time, information identifying the information processing apparatus, and information identifying the printing apparatus and records the collated results in a printing time database;
an examining unit which examines whether the multiple information processing apparatuses are in operation and, as a result, obtains information identifying the information processing apparatuses in operation;
a determining unit which determines, for each one of records in the printing time database, whether information identifying the information processing apparatus that is included in the record applies to the information identifying one of the information processing apparatuses in operation, whether the printing starting time included in the record is within a predetermined period, and whether the printing time included in the record is within a predetermined time;
a collecting unit which, when results of the determining for one of the records are all yes, a predetermined point is added to an information set identifying the printing apparatus included in the record, and collects the added point for each of the information sets identifying the printing apparatus recorded in the printing time database;
a decision unit which, while deciding to permit usage in order of a printing apparatus with a larger collection result of the multiple printing apparatuses within a range not exceeding a predetermined maximum consumed power, decides to set a printing apparatus for which usage is not permitted in a usage prohibition state in which only power needed for communicating with the printing management apparatus is supplied; and
a transmitting unit which transmits a notification for controlling the printing apparatuses based on decision results in the decision unit to the multiple printing apparatuses.

2. The printing apparatus management apparatus as claimed in claim 1, wherein, when deciding a printing apparatus for which usage is to be permitted, the decision unit decides such that at least one of an apparatus which has scanning and copying functions and one of an apparatus which has a printing function are included.

3. The printing apparatus management apparatus as claimed in claim 1, wherein
if the receiving unit receives information identifying a user who performed the user authentication after receiving the print request, the recording unit collates information identifying the information processing apparatus from which the printing request is transmitted and information identifying the user and records the collated results in an information processing apparatus user database; and
if the receiving unit receives information indicating a user authentication time, which is a time at which user authentication is performed at the time of carrying out scanning or copying in the printing apparatus and information identifying the user who performed the user authentication, the recording unit collates information identifying the printing apparatus, the user authentication time, and the identifying information to record the collated results in a scanning and copying execution database; and
for each one of records of the scanning and copying execution database, the determining unit searches for information identifying the information processing apparatus which applies to information identifying a user included in the record, determines whether information identifying the searched for information processing apparatus applies to information identifying an information processing apparatus which is in operation and whether user authentication time included in the record is within a predetermined period; and wherein,
when results of determining for one of the records are all yes, the collecting unit adds a predetermined point to information identifying the printing apparatus included in the record, collects added points for information identifying the printing apparatus that is recorded in the scanning and copying execution database, and integrates the collected results for each of the information sets identifying the printing apparatus and collected results based on the printing time database recording.

4. The printing apparatus management apparatus as claimed in claim 1, wherein the recording unit records printing times calculated by the calculating unit in time sequence, and the calculating unit calculates the printing time determined by the determining unit based on a printing time during which printing frequency is in a range which is no less than a specific value in a specific period recorded by the recording unit.

5. The printing apparatus management apparatus as claimed in claim 1, wherein the transmitting unit dynamically transmits information on most recent operating conditions that indicate which one of the multiple printing apparatuses decided by the decision unit is usage permitted to the information processing apparatus after the decision is made by the decision unit, or transmits the information on the most recent operating conditions to the information processing apparatus when there is a request from the information processing apparatus.

6. The printing apparatus management apparatus as claimed in claim 1, wherein, the decision unit may decide that a printing apparatus for which usage is not permitted is turned to another usage prohibition state which is different from a usage prohibition state in which only power necessary for communicating with the printing management apparatus is supplied, in which the other usage prohibition state power for preheating an engine related to image processing is also supplied in addition to power required for communicating with the printing management apparatus; and sets a number of printing apparatuses of printing apparatuses for which the usage is not permitted in the other usage prohibition state, the number being the number predetermined in an order from a printing apparatus with a large collection result and sets the remaining printing apparatuses in the usage prohibition state.

7. The printing apparatus management apparatus as claimed in claim 6, wherein the respective operations by the examining unit, the determining unit, the collecting unit, and the decision unit are set to be performed in a predetermined interval, and wherein the decision unit decides in advance the number of printing apparatuses to be set in the usage prohibition state and the other usage prohibition state based on the interval.

8. A printing apparatus, wherein, according to the notification received from the printing apparatus management apparatus as claimed in claim 1, the printing apparatus is adjusted to a state in which there is only power needed for communicating with the printing management apparatus, or a state in which there is power for preheating an engine in image processing in addition to the power needed for communicating with the printing management apparatus.
